(19) United States
(12) Patent Application Publication
(10) Pub. No.: US 2012/0010861 A1
(43) Pub. Date: Jan. 12, 2012

(54) Method for optimal selecting LED light sources and implementing full spectrum light

(75) Inventors: Neng-chung Hu, Taipei City (TW); Chin-chuan Wu, Taipei City (TW)

(73) Assignee: National Taiwan University of Science and Technology, Taipei City (TW)

(21) Appl. No.: 13/115,978

(22) Filed: May 25, 2011

(30) Foreign Application Priority Data
Jul. 8, 2010 (TW) 099122498

(51) Int. Cl. G06F 17/10; F21V 9/00

(52) U.S. Cl. 703/2; 362/231

(57) ABSTRACT

A method for optimal selecting light-emitting diode (LED) light sources for full spectrum lighting is disclosed. The optimal selecting method includes the following steps: gathering a plurality of spectral power distributions corresponding to LED light sources; arranging the spectral power distributions to obtain a matrix A corresponding to the LED light sources; calculating a reconstructed coefficient, which is a least-square approximation of the matrix with respect to a spectral power distribution of a CIE standard illuminant; and selecting a best combination of the LED light sources according to the reconstructed coefficient. An LED light source assembly is also disclosed.

### TECHNICAL FIELD OF THE INVENTION

The present invention relates to an LED light source, and especially to a method for optimal selecting LED light sources and an LED light source implementing full spectrum light.

### BACKGROUND OF THE INVENTION

Currently, a typical artificial light source on the market is usually a fixed color light, such as a fluorescent lamp, a color temperature box, stage or studio lighting, and so on. Generally, the fluorescent lamps or artificial light sources are collation color temperature. However, other characteristics such as a color rendering index (CRI), spectra and so on, do not satisfy the standard illuminants such as A Light, D65, D55, D50 standard illuminant in Commission International de l'Eclairage (CIE). The color rendering index (CRI) of said standard illuminants herein are set at 100, while the commercial artificial light e CRI is between 70 and 80. In addition, in order to achieve different color temperature requirements, the various lamps need to be substituted to satisfy the requirements.

To solve the above-mentioned drawback, in general method uses red, green, and blue light emitting diodes light sources for mixing, and individually controlling luminous intensity of the red, green, and blue LED as desired to change the color or the color temperature. However, each LED is a monochromatic light, so the spectrum mixed from red, green and blue LED is un-uniform and unable to reach a high color rendering index (CRI).

Therefore, there are many techniques at present using a variety of LEDs for color mixing to achieve a high color rendering index, as disclosed in U.S. patent 20080169770. However, it is a difficult decision to choose what kind and quantity additive colors of the LED light sources for optical mixing as there are many kinds of commercial LED light sources. Obviously, using a trial and error method to choose the LED light sources is time consuming and wasting money; moreover, there is no way of knowing whether the combination of the LED light sources obtained is a best combination in all commercial LED light sources.

### SUMMARY OF THE INVENTION

Accordingly, an objective of the present invention is to provide a optimal selecting method of LED light sources for solving knowing how to choose a best combination of LED light sources from the commercial LED light sources for color mixing

Another objective of the present invention is to provide an LED light source assembly to solve the drawback that the can not be tunable color temperature and reach a high color rendering index.

To achieve the foregoing objectives, according to an aspect of the present invention, a method for optimal selecting LED light sources is provided. The method is used to screen out a combination having a high color rendering index from an LED light source group, which the combination is similar to a spectral power distribution of a CIE standard illuminant. The optimal selecting method comprises the steps of: gathering a plurality of spectral power distributions corresponding to the LED light sources, wherein each said spectral power distribution is a plurality of luminous intensity values corresponding to a plurality of wavelengths of each said LED light source; arranging the spectral power distributions to obtain a matrix A corresponding to the LED light sources; calculating a reconstructed coefficient, which is a least-square approximation of the matrix A with respect to the spectral power distribution of the CIE standard illuminant; and selecting the best combination of the LED light sources according to the reconstructed coefficient.

In one preferred embodiment of the present invention, the least-square approximation is obtained by calculating a pseudo-inverse matrix of the matrix A multiplied by the spectral power distribution of the CIE standard illuminant, where the pseudo-inverse matrix is mathematically expressed as A⁺=(AA^{T})⁻¹A.

In another preferred embodiment of the present invention, the reconstructed coefficient has a plurality of numeric values, and each of the numeric values is positive and represents a contribution level of the corresponding LED light sources. The best combination of the LED light sources is selected from the LED light sources which correspond to the numeric values of the reconstructed coefficient for reaching the least-square approximation. For instance, the LED light sources group has 61 kinds of commercial LEDs, and the best combination is seven kinds of the LED light sources, wherein the color rendering index thereof is interposed between 85 and 90. More specifically, the seven kinds of the LED have the main wavelengths ranges thereof being respectively selected as 380 nm-420 nm, 480 nm-520 nm, 600 nm-630 nm, 645 nm-675 nm, 645 nm-720 nm, a blue phosphor LED light source, and a yellow phosphor LED light source. Moreover, the number of the LED light sources that is the best combination additives can be increased as desired according to the color rendering index.

According to another aspect of the present invention, a full spectrum light was implemented. It was comprised seven kinds of the LED light sources and a microprocessor. The seven kinds of the LED light sources have the main wavelength ranges thereof being respectively selected as 380 nm-420 nm, 480 nm-520 nm, 600 nm-630 nm, 645 nm-675 nm, 645 nm-720 nm, a blue phosphor LED light source, and a yellow phosphor LED light source. In addition, the microprocessor is electrically coupled to the seven kinds of the LED light sources for synchronously outputting a plurality of pulse width modulation (PWM) signals to each of the LED light sources, thereby modulating light having various color temperatures and a high color rendering index.

In still another preferred embodiment of the present invention, the full spectrum light assembly comprises the color rendering index between 85 and 90. The full spectrum light assembly further comprises an LED light source, wherein the main wavelength range of said LED light source is selected as 630 nm-645 nm, and the light has the color rendering index between 90 and 95.

In another preferred embodiment of the present invention, the full spectrum light assembly further comprises two LED light sources, wherein the two main wavelength range of said LED light sources is selected as 560 nm-560 nm and 630 nm-645 nm, also the light assembly has the color rendering index between 95 and 100.

According to the combination of LED chosen from the optimal selecting method of the present invention, the spectral power distribution can be approximated to a CIE standard illuminant, and the color rendering index is more than 85. Thus, the drawback that a variety of lamps that are needed and the only suitable color temperature can satisfy a CIE standard illuminant is solved. In addition, the combination of LED according to the method for optimal selecting method is the best combination. It is to be understood that both the foregoing general description and the following detailed description of the present invention are exemplary, explanatory and intended to provide further explanation of the invention as claimed.

### BRIEF DESCRIPTION OF THE DRAWINGS

FIG. 1 shows the spectrum of 61 kinds of commercial LEDs

FIG. 2 is a flow chart illustrating the method for optimal selecting LED light sources in a preferred embodiment of the present invention.

FIG. 3 shows the spectral power distribution of a D65 CIE standard illuminant.

FIG. 4 shows the values of the sampling points of the D65 CIE standard illuminant.

FIG. 5 shows the spectral power distributions which the nine kinds of the LED light sources simulated A t, D65, D55 and D50 CIE standard illuminant.

FIG. 6 is a block diagram illustrating a full spectrum light assembly according to one preferred embodiment of the present invention.

### DETAILED DESCRIPTION OF THE INVENTION

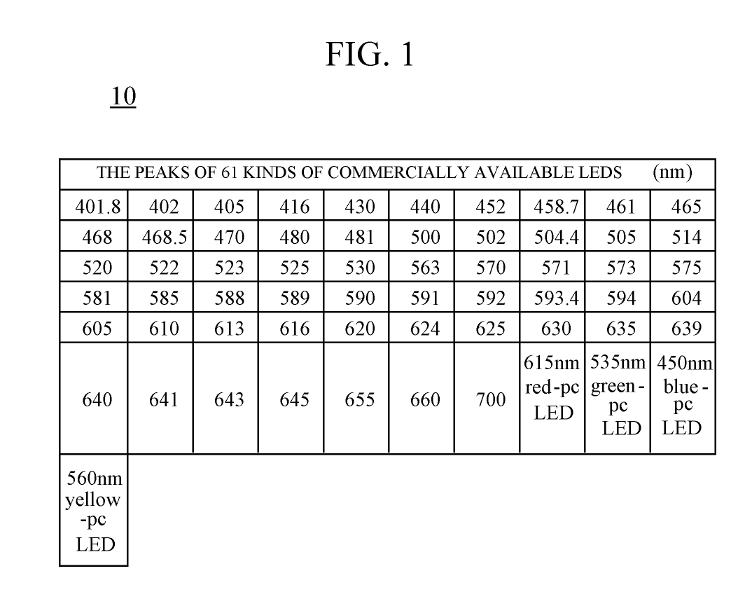

The following will explain a method for optimal selecting a plurality of light-emitting diodes (LEDs) according to one preferred embodiment of the present invention in detail with reference to the attached drawings. Referring to FIG. 1, FIG. 1 shows the spectrum of 61 kinds of commercial LEDs. The 61 kinds of commercial LEDs are generalized via gathering all commercial LED according to each respective spectral power distribution (SPD), and each is classified according to the wavelength at which the domain wavelength of each commercial LED. An LED light source group is designated as 10 according to the preferred embodiment of the present invention, wherein the LED light source group 10 comprises a plurality of LED light sources.

The method for optimal selecting LED according to the preferred embodiment of the present invention is applicable to select combination having a high color rendering index. The combination having a high color rendering index is similar to CIE standard illuminant. In the preferred embodiment, the CIE standard illuminant is a D65 standard illuminant. It should be noted that the CIE standard illuminant is not limited to the D65 standard illuminant, and it may also be selected from the group consisting of A, D65, D55, D50 and other CIE standard illuminant.

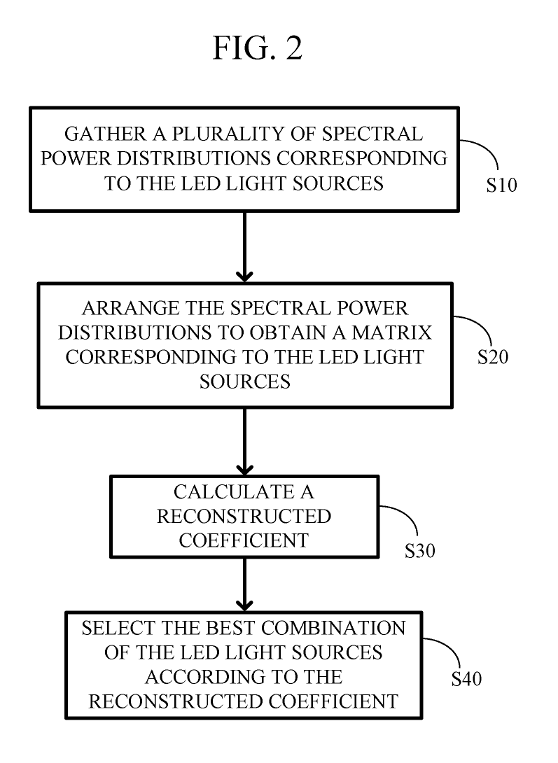

Referring to FIG. 2, FIG. 2 is a flow chart illustrating the method for optimal selecting LED in the preferred embodiment of the present invention. The method for optimal selecting LED begins with step S10.

At step S10, spectral power distribution corresponding to the LED light sources is gathered. Each of spectral power distribution is a plurality of luminous intensity values corresponding to a plurality of wavelengths of each of said LED light sources. For instance, the spectral power distribution of the first kind of the LED light sources (i.e., the domain wavelength is located at 401.8 nm) in the LED group 10 is obtained by gathering statistics, moreover, the spectral power distribution of the LED generally can be obtained from a datasheet of the LED component or can be obtained by measuring via a spectral radiometer. More specifically, the sampling points of the wavelength corresponding to the radiated intensity values that are selected in every 5 nm in the wavelength range between 400 nm and 700 nm. The sampling points in the following formulas are represented as d₁(1), d₁(2), . . . , d₁(61) (subscript “1” representing the first kind of the LED light sources), and d_{M}(1), d_{M}(2), . . . , d_{M}(61) represent the radiated intensity values corresponding to the wavelengths of the spectral power distribution of the M-th kind of the LED light sources. It should be understood that the numbers of 1 to 61 are due to sampling of every 5 nm between 400 nm and 700 nm. For this reason, there are 61 sampling points in each spectral power distribution. It should be noted that the present invention is not limited to gathering a sampling point every 5 nm. Moreover, there can be a sampling point gathered every 10 nm or 2 nm, thereby reducing the interval (2 nm) between sampling points for getting a more precise combination of the LED light sources.

At step S20, the spectral power distributions are arranged to obtain a matrix A corresponding to the LED light source. For instance, the spectral power distribution of the first kind of the LED light sources d₁(1), d₁(2), . . . , d₁(61) are arranged in the first row, the spectral power distribution of the second kind of the LED light sources d₂(1), d₂(2), . . . , d₂(61) are arranged in the second row, the spectral power distribution of the M-th kind of the LED light sources d_{M}(1), d_{M}(2), . . . , d_{M}(61) are arranged in the M-th row, and so forth. The matrix A of the ordered arrangement is the following equation 1:

$$A = [ \begin{matrix}{d}_{1} ( 1 ) & {d}_{1} ( 2 ) & … & {d}_{1} ( 61 ) \\ & & ⋮ & \\ {d}_{M} ( 1 ) & {d}_{M} ( 2 ) & … & {d}_{M} ( 61 )\end{matrix} ] \qquad equation 1$$

In the preferred embodiment, the LED light source group 10 has 61 kinds of the LED light sources, so the M-th row of the matrix A is the 61st row (i.e., M=61).

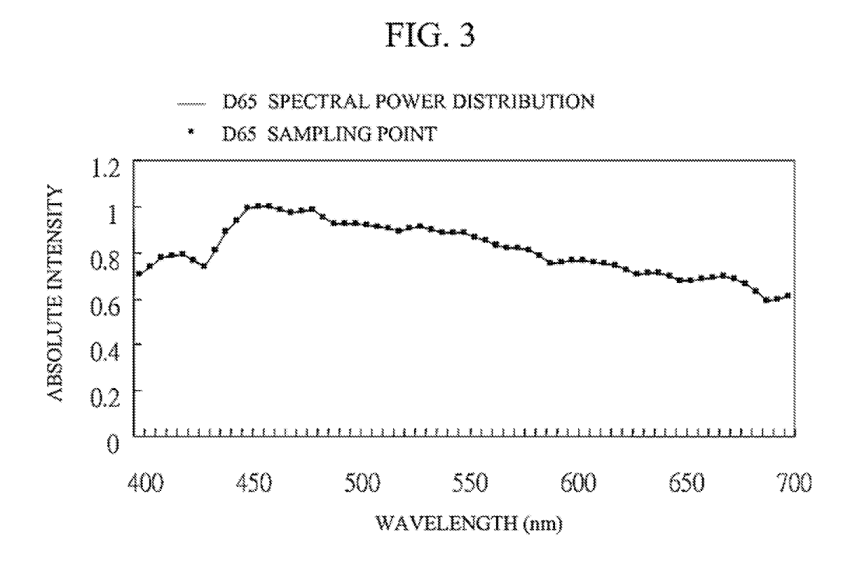

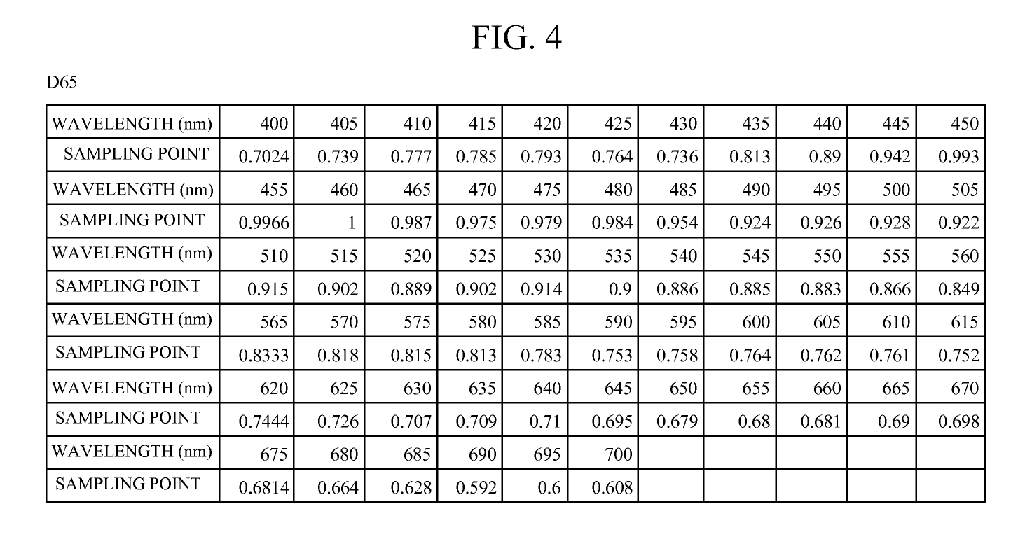

At step S30, a reconstructed coefficient is calculated, in which the reconstructed coefficient is a least-square approximation of the matrix A with respect to the spectral power distribution of the CIE standard illuminant. Referring to FIGS. 3 and 4, FIG. 3 shows the spectral power distribution of a D65 CIE standard illuminant, and FIG. 4 shows the values of the sampling points of the D65 CIE standard illuminant. In one preferred embodiment, the spectral power distribution of the D65 CIE standard illuminant is shown as a solid line in FIG. 3, where the horizontal axis represents the wavelength (nm) and the vertical axis represents an absolute intensity. The dots of FIG. 3 are the sampling points in every 5 nm, their specific values being shown in FIG. 4.

The 61 values of spectral power distribution of the D65 CIE standard illuminant in FIG. 4 represents as a 61×1 row vector. Accordingly, the reconstructed coefficient is a solution of equation 2 for linear algebra:

A^{T}X=Ē equation 2

It should be noted that A^{T} represents a transpose matrix of the matrix A, as shown in the following equation 3:

$${A}^{T} = [ \begin{matrix}{d}_{1} ( 1 ) & & {d}_{61} ( 1 ) \\ {d}_{1} ( 2 ) & & {d}_{61} ( 2 ) \\ ⋮ & … & ⋮ \\ {d}_{1} ( 61 ) & & {d}_{61} ( 61 )\end{matrix} ] \qquad equation 3$$

The X in equation 2 represents a 61×1 row vector. According to the matrix multiplication, the result of A^{T}X is another 61×1 row vector, and the first value (i.e., 1×1) of the A^{T}X is the sum of the intensities in certain proportions of the LED light source in the LED light source group 10. Ideally, the first value is the intensity of D65's spectral power distribution at 400 nm. In effect, because the LED light source group 10 can not fully reconstruct the spectral power distribution of the D65 CIE standard illuminant, the A^{T}X is not equal to E. Therefore, it requires a best approximate solution as shown in \hat{X}. The significance of “best” means is a minimum square error ∥\vec{E}−A^{T}\hat{x}∥² that is a least-squares approximation solution.

In linear algebra, the least-squares approximation solution, i.e., the vector \vec{E}, is obtained by calculating a pseudo-inverse matrix A⁺ of the matrix A multiplied by the spectral power distribution of the CIE standard illuminant, where the pseudo-inverse matrix is mathematically expressed as (AA^{T})⁻¹A. Accordingly, the reconstructed coefficient can be obtained by calculating (AA^{T})⁻¹A\vec{E}, which represents as a vector \vec{C}.

The reconstructed coefficient, that is, coefficients of the vector \vec{C} have a plurality of numeric values. In one preferred embodiment, the coefficients of the vector \vec{C} have 61 numeric values. As mentioned above, said numeric values represent the level of contributions of the corresponding LED light sources, so a negative value is unreasonable. Thus, each of the numeric values of the reconstructed coefficient is positive.

At step S40, the best combination of the LED is selected according to the reconstructed coefficient. Specifically, the best combination of the LED is selected from 61 kinds of LEDs corresponding to a plurality of maximum values of said numeric values. In one preferred embodiment, the LED light sources corresponds to the first 7 maximum values of said numeric values, and the color rendering index of the best combination of the LED light sources is interposed between 85 and 90. It should be noted that the number of the best combination of the LED light sources adds according to the color rendering index increasing as desired. For instance, the combination of the LED light sources requires 8 LED light sources while the color rendering index is interposed between 90 and 95; the combination of the LED light sources requires 9 LED light sources while the color rendering index is interposed between 95 and 100.

In accordance with the method for optimal selecting LED, similarly, it can be used to select the best combinations that correspond with the CIE standard illuminant such as A t, D55, D65 and D50 reconstructed by seven kinds of the LED. Accordingly, the seven better wavelength ranges can be obtained by counting said seven kinds of the LED which satisfy said CIE standard illuminants. For instance, if the seven LED light sources within the seven wavelength ranges are used to simulate the spectral power distribution of D65, the intensities of the seven LED light sources can be modulated to satisfy the spectral power distribution of D65 according to the ratio of the seven maximum values of said calculated reconstructed coefficient.

Similarly, if the seven LED light sources within the seven wavelength ranges are used to simulate the spectral power distribution of D55, the intensities of the seven LED light sources can be modulated to satisfy the spectral power distribution of D55 according to the ratio of the seven maximum values of the calculated reconstructed coefficient. The calculated reconstructed coefficient of D55 herein is the pseudo-inverse matrix multiplied by the spectral power distribution of D55.

In one preferred embodiment, the main ranges of the calculated seven kinds of the LED light sources are respectively selected as 380 nm-420 nm, 480 nm-520 nm, 600 nm-630 nm, 645 nm-675 nm, 645 nm-720 nm, a blue phosphor LED light source, and a yellow phosphor LED light source. The LED light sources can be respectively modulated to satisfy the CIE standard illuminant such as A, D55 and D50, and the color rendering index of the best combination of the seven LED light sources is interposed between 85 and 90.

The combination of the LED light sources requires adding one LED light source while the color rendering index is interposed between 90 and 95, which the wavelength of the LED light source is selected as 630 nm-645 nm. The combination of the LED light sources requires adding two LED light sources while the color rendering index is interposed between 95 and 100, which the wavelengths of the two LED light sources are selected as 560 nm-600 nm and 630 nm-645 nm.

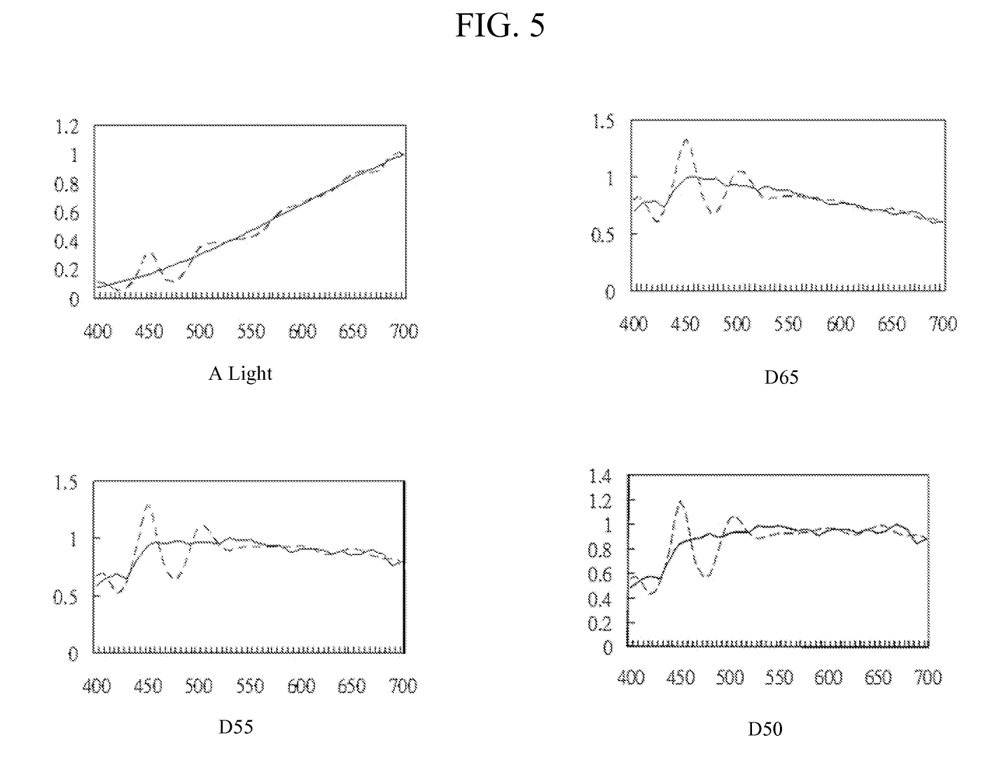

Referring to FIG. 5, FIG. 5 shows the spectral power distributions which the nine kinds of the LED light sources simulated A, D65, D55 and D50 in the preferred embodiment. Solid lines herein indicate the spectral power distributions of A, D65, D55 and D50, and dashed lines indicate the spectral power distributions simulated by the nine kinds of the LED light sources having the main ranges thereof being respectively selected as 380 nm-420 nm, 480 nm-520 nm, 600 nm-630 nm, 645 nm-675 nm, 645 nm-720 nm, 560-600 nm, 630-645 nm, the blue phosphor LED light source, and the yellow phosphor LED light source.

As mentioned above, the spectral power distribution thereof can be similar to a CIE standard illuminant, and the color rendering index is more than 95. Thus, the present invention can overcome the drawbacks that a variety of lamps are required to be used and having only one color temperature to satisfy a CIE standard illuminant.

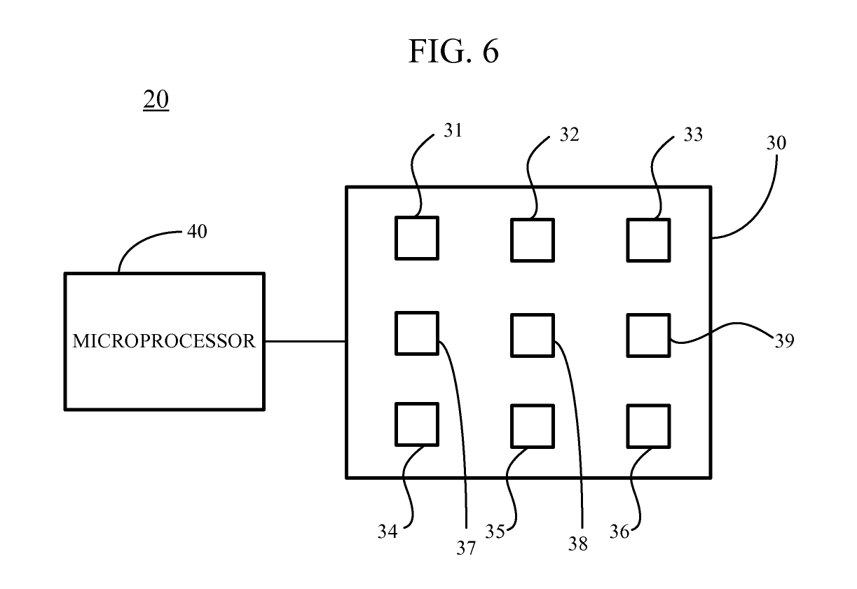

In addition, the following detailed explanation of the full spectrum light according to one preferred embodiment of the present invention coincides with the accompanying drawings. Referring to FIG. 6, FIG. 6 is a block diagram illustrating an LED light source assembly according to one preferred embodiment of the present invention. The full spectrum light assembly is designated as 20, which the light assembly includes 7 LED light sources with different wavelengths (designated at 31, 32, 33, 34, 35, 36, and 37), and a microprocessor 40. The LED light sources 31-37 are disposed on a lead frame 30, and LED light sources 31-37 which are selected method for optimal selecting LED light sources are 380 nm-420 nm, 480 nm-520 nm, 600 nm-630 nm, 645 nm-675 nm, 645 nm-720 nm, a blue phosphor LED light source, and a yellow phosphor LED light source.

One end of each pin of the LED light sources 31-37 is grounded, and the other end thereof are electrically coupled to the microprocessor 40. The microprocessor synchronously output a plurality of pulse width modulation (PWM) signals to each of the LED light sources 31-37 for controlling the brightness of each LED light sources 31-37, thereby reaching the effect of modulating various CIE standard illuminants such as A Light, D65, D55 and D50.

The PWM signals are the light-emitting time of the LED light sources 31-37 in a period, which the light-emitting time the can be distributed according to the ratio of the seven maximum values of the reconstructed coefficient to modulate the CIE standard illuminants such as A, D65, D55 and D50. In addition, the LED light source assembly has the color rendering index being interposed between 85 and 90.

In one preferred embodiment, similarly, the full spectrum light requires adding one LED light source 38 while the color rendering index is interposed between 90 and 95, which the wavelength of the LED light source 38 is selected as 630 nm-645 nm. The LED light source assembly requires adding two LED light sources 38 and 39 while the color rendering index is interposed between 95 and 100, which the wavelengths of the two LED light sources 38 and 39 are selected as 560 nm-600 nm and 630 nm-645 nm.

As mentioned above, the full spectrum light 20 has a combination of the LED light sources with a high color rendering index, and the spectra can be modulated by the single combination of the LED light sources as any color temperature or any said standard illuminants desired. Moreover, the light 20 has the results of the various CIE standard illuminants into one without the troublesome processes of installing various light sources for producing various color temperatures, and can save cost and space to achieve the corresponding standard illuminants.

While the preferred embodiments of the present invention has been illustrated and described in detail, various modifications and alterations can be made by persons skilled in this method. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A method for optimal selecting a plurality of light-emitting diode (LED) light sources, wherein said method is used to screen out a combination having a high color rendering index from an LED light source group, so that the combination is similar to a spectral power distribution of a CIE standard illuminant, the optimal selecting method comprising the steps of:
gathering a plurality of spectral power distributions corresponding to the LED light sources, wherein each said spectral power distribution is a plurality of luminous intensity values corresponding to a plurality of wavelengths of each said LED light source; arranging the spectral power contributions to obtain a matrix A corresponding to the LED light sources; calculating a reconstructed coefficient, which is a least-square approximation of the matrix A with respect to the spectral power distribution of the CIE standard illuminant; and selecting the best combination of the LED light sources according to the reconstructed coefficient.

2. The method of claim 1, wherein the least-square approximation is obtained by calculating a pseudo-inverse matrix (AA^{T})⁻¹A of the matrix A multiplied by the spectral power distribution of the CIE standard illuminant.

3. The method of claim 1, wherein the reconstructed coefficient has a plurality of numeric values, each of the numeric values being positive and representing a contribution level of the corresponding LED light sources.

4. The method of claim 1, wherein the LED light source group comprises a plurality of commercial LED light sources, and the best combination of the LED is seven kinds of the LED light sources.

5. The method of claim 4, wherein the main wavelength ranges of the seven kinds of the LED light sources are respectively selected as 380 nm-420 nm, 480 nm-520 nm, 600 nm-630 nm, 645 nm-675 nm, 645 nm-720 nm, a blue phosphor LED light source, and a yellow phosphor LED light source.

6. The method of claim 4, wherein the number of the LED light sources of the best combination adds according to the color rendering index increasing as desired.

7. An LED light source assembly, comprising:
seven kinds of the LED light sources having main wavelength ranges being respectively selected as 380 nm-420 nm, 480 nm-520 nm, 600 nm-630 nm, 645 nm-675 nm, 645 nm-720 nm, a blue phosphor LED light source, and a yellow phosphor LED light source; and a microprocessor electrically coupled to the seven kinds of the LED light sources for synchronously outputting a plurality of pulse width modulation (PWM) signals to each of the LED light sources for modulating light having various color temperatures and a high color rendering index.

8. The LED light source assembly of claim 7, wherein the LED light source assembly has the color rendering index being interposed between 85 and 90.

9. The LED light source assembly of claim 7 further comprising an LED light source, the main wavelength range of said LED light source being selected as 630 nm-645 nm.

10. The LED light source assembly of claim 7 further comprising two LED light sources, the main wavelength ranges of said two LED light sources being selected as 560 nm-600 nm and 630 nm-645 nm.
